(19) United States
(12) Patent Application Publication
(10) Pub. No.: US 2002/0100660 A1
(43) Pub. Date: Aug. 1, 2002

(54) Automatic cash handling machine with wireless networked I/O devices

(76) Inventors: Jon R. Stieber, Oconomowoc, WI (US); Thomas P. Adams, Oconomowoc, WI (US); Robert L. Zwieg, Watertown, WI (US); William R. Kirkman, Mukwonago, WI (US)

Correspondence Address: QUARLES & BRADY LLP, 411 E. WISCONSIN AVENUE, SUITE 2040, MILWAUKEE, WI, 53202-4497, US

(21) Appl. No.: 10/004,738

(22) Filed: Dec. 4, 2001

Related U.S. Application Data
(60) Provisional application No. 60/251,307, filed on Dec. 4, 2000.

(51) Int. Cl. G06M 1/00; G06M 3/00; G07F 9/08

(52) U.S. Cl. 194/215; 194/206

(57) ABSTRACT

An electronically controlled cash handling device (12) has a CPU (21), a program memory (23), a cash handling functions I/O portion (25), a radio transceiver (24) operating according to the Bluetooth specification and an antenna (26). The device (12) can communicate through wireless communication to a peripheral cash handling device (13) which supplements the cash handling functions of the base machine (12). The cash handling device (12) can also communicate through the wireless network with computer peripheral I/O devices (14), such as a printer (18), batch display (20) and scanner (22) to enhance the capabilities of the system.

### CROSS REFERENCE TO RELATED APPLICATION

The benefit of priority based on U.S. Prov. Patent Appl. No. 60/251,307, filed Dec. 4, 2000, is claimed herein.

### TECHNICAL FIELD

The present invention relates to automated cash handling equipment, and more particularly to a cash handling machine that is networked to peripheral devices through a wireless communication network.

Automated cash handling equipment is utilized in retail trade, banking and gaming industries and anywhere else where large amounts of notes or coinage must be counted, sorted and packaged. Automated note and coin counting equipment is used in bank vaults and other locations for both sorting and counting deposits. Note and coin counters can also be used by tellers to verify the value of transactions prior to issuing a receipt to a customer. In gambling casinos, gaming machines must be “cashed up”, which means that a certain base level of cash must be provided for operation, but excess cash resulting from gambling must be removed. Cash redemption centers now allow consumers to bring in their accumulated change, for counting and exchange for a voucher for shopping at a retail food store, for example.

While automated cash handling systems are advantageous for businesses in which significant levels of cash are exchanged, there are also problems associated with these systems. Cash dispensing machines contain a limited supply of money. The supply level in these machines must be monitored and the machine refilled to maintain the supply of available cash at or above a minimum level such that a sufficient supply is available for customers. Cash receiving machines, on the other hand, can only accept a limited amount of money. These machines must be monitored and emptied when necessary to prevent, for example, expensive downtime for gaming machines. Additionally, because automatic cash handling machines handle large amounts of cash, it is important to be able to verify both that the equipment is operating as expected and that personnel involved in loading and unloading the machines are doing so correctly. It is desirable, therefore, to monitor cash levels in automated cash handling machines.

Bergmann et al., U.S. Pat. No. 5,222,583, discloses a group of gaming machines which are co-located with a money changing machine. A master device may collect data from the gaming machines through an RF network, and pass such data on to a central control unit. Japanese Patent Application Publication No. 11114209 shows a plurality of coin counting units, perhaps located at a point of sale, which transmit cash collection data to a central control unit via RF communications. Japanese Patent Application Publication No. 6312061 shows a gaming machine management system in which cash accumulation data is collected and transmitted to a floor management machine, and then to a central computer.

There remains a need for automated cash handling equipment that can be networked through wireless communication networks to perform the full range of cash handling functions.

### SUMMARY OF THE INVENTION

The invention is provided in an electronically controlled cash handling device comprising a processing portion, a program memory for storing a program for execution by the processing portion, a cash input/output portion, the cash input/output portion processing I/O data related to a cash transaction performed by the cash handling device, and a radio transceiver and antenna, the radio transceiver transmitting signals to and receiving signals from the processing unit for communicating cash transaction data to and from an external device.

The present invention is an automatic cash handling device such as a note counter, note dispenser, coin sorter or coin dispenser which includes a wireless network transceiver for communicating data through a wireless network to additional cash handling machines and to computer peripheral I/O devices. The invention is particularly applicable to small stand-alone systems requiring one or more cash handling devices and/or peripheral input/output devices.

In addition, the I/O devices can be added to the system, including peripheral input, output, and communication devices such as displays and printers; scanners, keyboards, and touch screens, and pagers, cellular phones, and personal digital assistants, among other known devices.

Preferably, the cash handling devices are linked via RF communication devices employing one of the industry standard specifications, such as the Bluetooth specification, the IrDA specification, the Home RF specification or the SWAP protocol (an enhancement of the IEEE 802.11 standard). The Bluetooth specification requires operation in a universally available instrumentation, scientific, and medical (ISM) frequency band, and can be easily installed in known devices through the addition of a single Bluetooth radio microchip.

Other objects and advantages of the invention, besides those discussed above, will be apparent to those of ordinary skill in the art from the description of the preferred embodiments which follow. In the description, reference is made to the accompanying drawings, which form a part hereof, and which illustrate examples of the invention.

### BRIEF DESCRIPTION OF THE DRAWINGS

FIG. 1 is a block diagram of an automatic cash handling device and networked devices in accordance with the present invention.

FIG. 2 is a block diagram of a first cash handling device of FIG. 1.

FIG. 3 is a block diagram of a second cash handling device of FIG. 1.

### DETAILED DESCRIPTION OF THE PREFERRED EMBODIMENTS

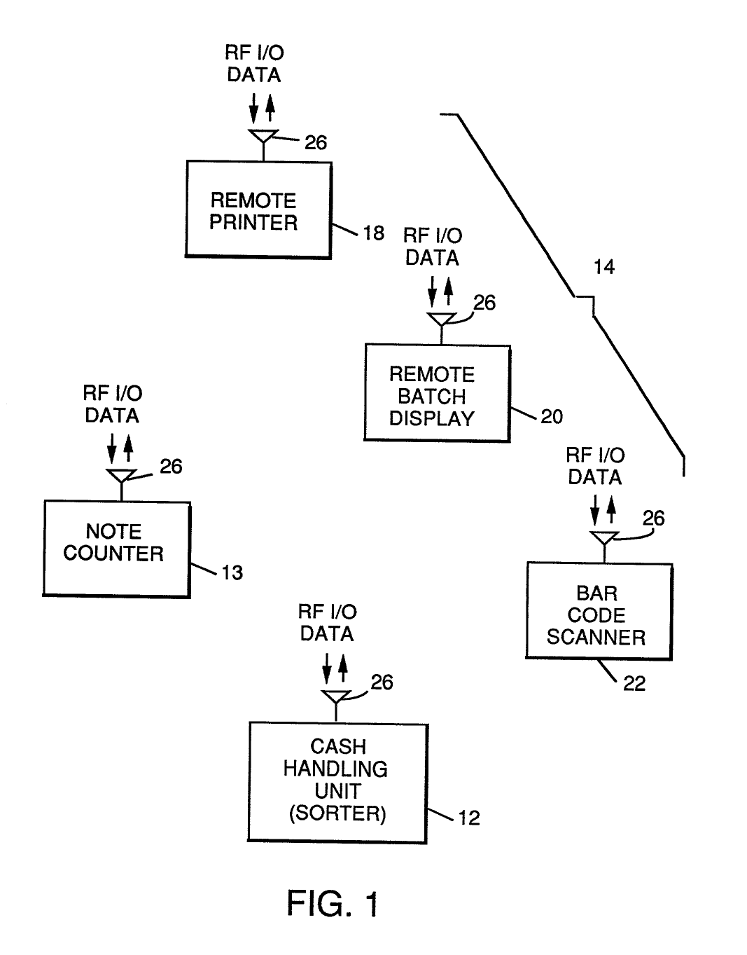

FIG. 1 is a block diagram of a cash handling unit 12, such as a coin sorter, arranged in a wireless network with a peripheral cash handling unit 13, a note counter, and peripheral I/O devices 14, comprising a remote printer 18, a remote batch display 20 and a bar code scanner 22. The cash handling device 12 can be constructed to perform the function of a number of known automatic cash handling machines including coin sorting and totalizing, note counting, coin dispensing, note dispensing, note sorting and totalizing and cash redemption. The automatic cash handling device 12, the remote peripheral devices 14, and remote cash handling devices 13 each includes a transceiver (not shown in FIG. 1) and an antenna 26 for wireless transmission and receipt of data and instructions from other devices. Both the cash handling devices 12, 13 and peripheral I/O devices 14 can preferably communicate in both directions with each other.

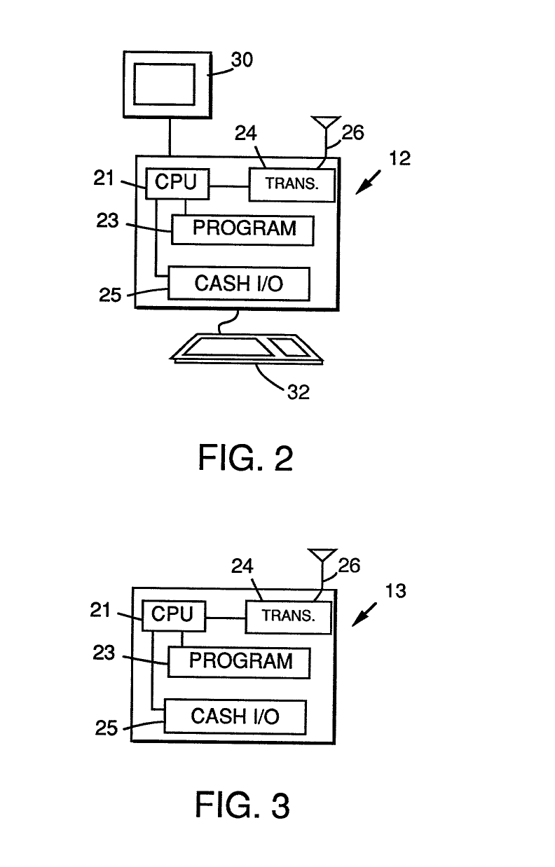

Referring now to FIG. 2, a block diagram of the automatic cash handling device 12 of the present invention includes controller or CPU 21, a program memory 23, an RF transceiver 24, a cash I/O portion 25 and an antenna 26. The program memory 23 stores a program for execution by the CPU 21. The cash I/O portion 25 includes hardware and/or software for calculating, storing, processing and transmitting cash handling data. The transceiver 24 is preferably an RF transmitter and receiver operating in accordance with the Bluetooth communications specification. However, transceivers operating according to other specifications such as IrDA for infrared communication ports, Home RF and SWAP (Shared Wireless Access Protocol) (IEEE 802.11) can also be used. These networks operate in a range of frequencies which are available for locally distributed systems in which the equipment is no further apart than a range of from approximately 2 meters to approximately 100 meters. The base cash handling device 12 can also include a display 30 (either a CRT, LCD, LED, or after type of display device), keyboard 32, or other input/output devices that allow a user to enter information into and receive data from the cash handling device 12.

In addition, the cash I/O portion 25 enables the cash handling device to provide one or more selected cash management functions. Typical cash management functions include coin and note counting, sorting, and dispensing. Coin and note sorters are devices for receiving and sorting cash into various denominations. In some applications, coin and note sorters can be combined with coin dispensers and other devices for providing packages with a predetermined number of coins. Coin and note dispensers provide a selected number or value of coins to a customer, and are commonly used in change dispensing machines, coin-for-note and note-for-coin exchange machine, gaming machines, and other devices. Note counters and coin counters are devices which count the number of notes and coins of a single denomination. Sorters for notes and coins are devices which both sort and totalize cash by denomination and batch. These functions can be provided in a “stand alone” device, or can be combined into more sophisticated cash management devices such as cash redemption centers and gaming machines.

The peripheral I/O devices 14 can include a number of typical devices configured to include a transceiver and antenna for communicating with the cash handling machine 12. Such devices can include printers 18, displays 20 and scanners 22, as shown in FIG. 1. The printer 18 can, for example, provide hard copy documents accounting for cash received at or distributed from each of the distributed cash handling devices, while the display 20 can provide a real-time count of cash received and distributed at each of the devices. The scanner 22 can be used in a number of known ways, including as an input device for receiving coupons or vouchers, or for identifying employee or customer identification cards. Other input devices (not shown) such as keyboards, voice recognition systems, or page scanners can also be used as peripheral devices. Peripheral I/O devices 14 can also include fax machines, LED or LCD text displays, video displays, and other devices. Communication devices such as pagers, cellular phones, personal digital assistants, and laptops can also be employed as peripheral I/O devices 14. These devices can be used, for example, to provide a signal to a floor manager indicating that a given cash handling machine is empty or full, or requires maintenance or service.

FIG. 3 is a block diagram of the details of a cash handling device 13 distributed some distance from the base cash handling device 12. The remote cash handling machine 13 comprises hardware and/or software (cash I/O) 25 for calculating, processing, storing, and transferring data. The cash handling device 13 also includes a controller or CPU 21, a program memory 23, an RF transceiver 24 and antenna 26. As noted above, the transceiver 24 is preferably an RF transmitter and receiver operating in accordance with the Bluetooth communications specification, however, other types of communications specifications can be used. The remote or distributed cash handling device 13 can include a display, keyboard, or other input/output device as described above, but is generally designed as a device which requires minimum customer interface since communication is provided mainly through the base cash handling device 12. The cash I/O portion 25 provides one or more selected cash management function of the type described above with reference to the automatic cash handling device 12. The addition of the remote device 13 to the base unit 12 adds to the cash handling functions of the base unit 12. In the communications protocol, the remote cash handling device 13 is preferably configured to be controlled by the automatic cash handling device 12.

In operation, the automatic cash handling device 12 is programmed to calculate and store data related to a specific internal cash handling operation, and to act as a controller to peripheral devices 14 and remote cash handling machines 13. When the cash handling device 12 is configured as a coin counter or a note counter, for example, the device provides data such as total value of cash counted, a tally of the available notes or coins by denomination, or other information. Similarly, a cash handling device 12 configured as a coin dispenser or note dispenser can provide accounting data such as total value of cash dispensed, total number of coins or notes of a single denomination dispensed, or a total of the remaining cash available in the dispenser. In addition, the cash handling device 12 can detect, store, and transmit status information including data related to error conditions encountered, and maintenance or service data.

The cash handling device 12 can also provide commands to and receive data from peripheral I/O devices 14. The cash handling device 12 can transmit data to a printer 18 or display 20 to provide batch information, error information, accounting totals, total number of coin or note denominations available, or other information. The cash handling device 12 can also provide error or maintenance information, including “machine full” or “machine empty” information to communication devices such as pagers and cellular phones. This information can assure rapid correction of such conditions and prevent down time for coin or note dispensing and receiving machines. The cash handling device 12 can also receive information from peripheral I/O devices 14. For example, batch information and employee identification information can be received from a peripheral bar code or scanner device. Peripheral I/O devices 14 such as scanners, magnetic readers, and keyboards can also be used to scan and verify vouchers, debit and credit cards, customer identification cards, and other information.

As noted above, the cash handling machines 12 can also communicate with the cash handling machines 13 which provide coin sorting and counting, note sorting and counting, and note and coin dispensing functions. Data collected by the remote cash handling machines 13 is transmitted to the cash handling device 12, which can be programmed to monitor available cash levels, and provide cash settlement and batching functions for transactions. The cash handling device 12 can also provide error and maintenance monitoring for each of the remote cash handling machines 13. Furthermore, the cash handling device 12 can provide commands to the remote cash handling machines 13. Commands can include, for example, instructions to halt operation of a malfunctioning cash handling device and/or provide an error display, instructions to display a machine empty, machine full, or other warning messages, and instructions to switch to a new batch for a counting operation. The cash handling device 12 can also be used to maintain database information related to completed transactions, malfunctions and system errors, machine usage, and other data.

Although a number of applications of the present invention are possible, one application of the present system is in the field of banking. One common banking application involves a teller receiving a deposit from a customer. The teller applies the deposit to a first cash handling device 12 constructed as a coin counter. The first cash handling device 12 is coupled to a second cash handling device 13 which provides the function of a note counter, and to three peripheral I/O devices 14. The peripheral I/O devices can be, for example, a printer 18 for printing transaction data and receipts, a batch display 20 for displaying accounting data by transaction, and a bar code scanner 22 for identifying each batch. The first cash handling device 12 counts and stores the value of the coins deposited, and requests a similar total of the value of notes counted from the second cash handling device 13. The results can be displayed directly on a display associated with the cash handling device 12, or transmitted to the batch display 20 or printer 18. In some applications, a peripheral I/O device 14 such as a scanner 22 can be used to apply a bar code identifier to each deposit, to each teller or employee, or to each customer. Because the cash handling devices 12, 13 communicate through wireless networks, the devices 12, 13 can be positioned where they are most convenient for each individual teller.

Although a number of known RF transceiver devices can be used in the present invention, communications between the cash handling device 12 and peripheral devices 13, 14 is preferably provided in accordance with the Bluetooth specification. Bluetooth communications are provided by a single chip Bluetooth radio comprising a radio-frequency transceiver, a baseband link control unit and associated link software, and an antenna subsystem. The radio uses frequency-hopping spread-spectrum technology in the unlicensed industrial, scientific, and medical (ISM) band. In North America and most of Europe, frequency hopping occurs over seventy-nine channels spaced 1 MHz apart between 2.4 and 2.56 GHz. Bluetooth radios switch frequencies up to 1600 times per second, and the data packets are kept small, so as not to interfere with other RF devices nearby.

The baseband protocol of the current Bluetooth specification allows for both circuit and packet switching. Data is transmitted via asynchronous links dedicated to data access links such as dial-up networks, facsimile, and local area network access. These links can use a number of known protocols. In the present application, the links between devices are preferably selected to emulate an RS-232 serial link. This link emulates the communication method employed in prior art serial communication networks, and can therefore be easily implemented and integrated with existing devices. Communications can be point-to-point or point-to-multipoint. Security features, including authentication and encryption algorithms, can be used to secure communications between devices.

Under the current Bluetooth specification, up to eight Bluetooth devices can be linked together into a “piconet”. Each piconet includes one master and up to seven slave devices, and is distinguished from surrounding piconets by the selected frequency hopping sequence. By associating one remote device in a first piconet to a control unit in a second piconet, piconets can be linked together into “scatternets”. The scatternets allow communication among continually flexible configurations of control units and distributed devices.

Referring again to FIG. 1, in the preferred embodiment, the cash handling device 12, peripheral device 14, and remote cash handling machines 13 are each constructed to include a Bluetooth radio. The cash handling device 12 is configured to act as a device, and the peripheral devices 14, and remote cash handling machines 13 are configured to act slaves. The master device is communicatively coupled to a plurality of slave units via an RF link emulating an RS-232 communication cable, constructed in accordance with the Bluetooth specification. The master unit can be coupled in a network such as a LAN or WAN, or to a public communications link such as an intranet or internet communications link. This link can be provided through a Bluetooth RF connection or an alternative modem connection, such as those described above. Although an RS-232 connection has been described, this selection has been made to provide ease of transition between existing equipment and the preferred embodiment.

This has been a description of the preferred embodiment and some alternative embodiments. For the embodiments falling within the spirit and scope of the present invention, reference is made to the claims which follow.

1. A cash management system comprising:
a first cash handling device for performing at least one of the operations of coin sorting, coin dispensing, note dispensing, note sorting, cash redemption, monitoring cash handling, accounting for cash dispensing, providing for cash settlement, monitoring maintenance information and providing commands for controlling operation of at least one of other cash handling device;
a second cash handling device for performing at least one of the operations of coin counting, coin sorting, coin dispensing, note counting, note dispensing, note sorting and cash redemption that adds to the functional capabilities to the cash management system beyond the functional capabilities of the first cash handling device; and
wherein said first cash handling device and said second cash handling device communicate through a wireless communication network operating according to a network standard for locally distributed wireless networks.

2. The cash management system of claim 1, further comprising at least one I/O device selected from a group consisting of: a printer, a scanner, a visual display, a keyboard, a cell phone, a pager, a personal digital assistant and a personal computer.

3. The cash management system of claim 1, wherein the first cash handling device is electrically connected to a second network selected from a group consisting of: the Internet, an intranet, a LAN and a WAN.

4. The cash management system of claim 3, wherein the second network utilizes at least one of a telephone dial-up modem, a digital satellite link modem and a broadband cable modem.

5. The cash management system of claim 1, wherein the wireless communication network operates according to the Bluetooth specification.

6. The cash management system of claim 5, wherein the wireless communication network further operates according to the RS-232 protocol.

7. The cash management system of claim 1, wherein the wireless communication network operates in a frequency hopping, spread spectrum range of frequencies in a range from 2.4 Ghz to 2.56 GHz.

8. The cash management system of claim 1, wherein the wireless communication network operates in an infrared frequency range according to the IrDA standard.

9. The cash management system of claim 1, wherein the wireless communication network operates in a piconet distinguished from other networks by a selected frequency hopping sequence.

10. An electronically controlled cash handling device, comprising:
a processing portion;
a program memory for storing a program for execution by the processing portion;
a cash input/output portion, the cash input/output portion processing I/O data related to a cash transaction performed by the cash handling device; and
a radio transceiver and antenna, the radio transceiver transmitting signals to and receiving signals from the processing unit for communicating cash transaction data to and from an external device.

11. The cash handling device of claim 10, wherein the radio transceiver communicates cash handling data according to the Bluetooth communication specification.

12. The cash handling device of claim 10, wherein the cash input/output portion performs at least one of the following operations: coin sorting and totalizing, coin dispensing, note sorting and totalizing, and note dispensing.

13. The cash handling device of claim 12, wherein the radio transceiver communicates cash handling data according to the Bluetooth communication specification.

14. The cash handling device of claim 11, further comprising at least one I/O device selected from a group consisting of: a printer, a scanner, a visual display, a keyboard, a cell phone, a pager, a personal digital assistant and a personal computer.
